(19) United States
(12) Patent Application Publication
(10) Pub. No.: US 2026/0208072 A1
(43) Pub. Date: Jul. 23, 2026

(54) STORM WATER OIL RECOVERY SYSTEM

(71) Applicant: SAUDI ARABIAN OIL COMPANY, Dhahran (SA)

(72) Inventors: Pavel Dragos HORATIU, Dhahran (SA); Talal Abdullah ALJOAIB, Dhahran (SA); Fadi Monhem ARBID, Dhahran (SA); Ali Mohammed AL ABBAS, Dhahran (SA); Samusideen Adewale SALU, Dhahran (SA)

(73) Assignee: SAUDI ARABIAN OIL COMPANY, Dhahran (SA)

(21) Appl. No.: 19/035,347

(22) Filed: Jan. 23, 2025

(51) Int. Cl. B01D 17/04; B01D 17/12

(52) U.S. Cl. CPC B01D 17/047; B01D 17/12; B01D 2221/04; B01D 2221/12; B01D 2257/80

(57) ABSTRACT

An oil recovery system includes an evaporation pond, a structure defining first and second skimmers, the structure including a weir wall dividing the first skimmer from the second skimmer, and the weir wall defining an opening extending between the first and second skimmers. A valve is disposed in the first skimmer at the opening and is closed to block fluid communication between the first and second skimmers through the opening when a fluid level within the first skimmer is at or above a threshold level, and is opened to allow fluid communication between the first and second skimmers through the opening when the fluid level is below the threshold level. A T-shaped pipe is partially disposed within the second skimmer to fluidly couple the second skimmer to the evaporation pond.

### FIELD OF THE DISCLOSURE

The present disclosure relates generally to an oil recovery system. More particularly, the oil recovery system is configured to skim oil from storm water runoff received from an onshore oil facility.

### BACKGROUND OF THE DISCLOSURE

Onshore oil facilities, including refineries, drilling sites, and storage areas, face significant challenges related to the contamination of storm water with oil and other hydrocarbons. During rainfall, storm water runoff can collect oils, greases, and various other pollutants from the surfaces of these facilities. If not properly managed and instead released into environment, this contaminated storm water can pose severe environmental hazards.

Conventional oil recovery system systems for onshore oil facilities face frequent problems with oil contamination. Some conventional oil recovery systems include a two chambered sump to facilitate separating the oil from the water. However, the two chambered sump is prone to oil contamination since the fluid level within the sump can cause oil to enter the chamber designed to contain relatively clean water waiting to be conveyed to an evaporation pond. Also, conventional oil recovery systems do not have sufficient capacity to process high volume precipitation events which leads to oil entering the evaporation pool (pond) or even the environment.

Thus, there is a need in the art for an oil recovery system that can efficiently separate oil from the storm water received from an onshore oil facility.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for recovering oil from storm water derived from an oil processing facility comprises conveying storm water comprising water ladened with oil to a first oil skimmer. The method further comprises conveying a portion of the storm water from the first oil skimmer into a sump pit in fluid communication with the first oil skimmer. The method further comprises pumping the portion of the storm water from the sump pit to an oil recovery tank. The method further comprises overflowing the storm water from the first oil skimmer to a second oil skimmer over a separator wall arranged between the first oil skimmer and the second oil skimmer. The method further comprises allowing the oil to separate from the water. The method further comprises conveying water accumulated in the second oil skimmer to an evaporation pond through one or more T-shaped pipes.

According to an embodiment consistent with the present disclosure, an oil recovery system comprises a first oil skimmer, a sump pit, one or more pumps, a second oil skimmer, and an evaporation pond. The first oil skimmer receives storm water comprising water ladened with oil from an oil processing facility. The sump pit in fluid communication with the first oil skimmer through a first drain, wherein the sump pit receives a portion of the storm water from the first oil skimmer. The one or more pumps are arranged in the sump pit and operable to pump the portion of the storm water from the sump pit to an oil recovery tank. The second oil skimmer is separated from the first oil skimmer by a separator wall, wherein the second skimmer receives a portion of the storm water from the first oil skimmer when the storm water overflows the separator wall. The evaporation pond is in fluid communication with the second oil skimmer to receive a portion of the water accumulated in the second oil skimmer and that has separated from the oil.

According to an embodiment consistent with the present disclosure, an oil recovery system comprises an evaporation pond, a structure, a valve, and a T-shaped pipe. The structure defining a first skimmer and a second skimmer, the structure including a weir wall dividing the first skimmer from the second skimmer, and the weir wall defining an opening extending between the first and second skimmers. The valve is disposed in the first skimmer at the opening, the valve being closed to block fluid communication between the first and second skimmers through the opening when a fluid level within the first skimmer is at or above a threshold level, and being opened to allow fluid communication between the first and second skimmers through the opening when the fluid level is below the threshold level. The T-shaped pipe is partially disposed within the second skimmer to fluidly couple the second skimmer to the evaporation pond, the T-shaped pipe including a first portion and a second portion that intersects the first portion, the first portion including an inlet and an open end and the second portion including an outlet.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

So that the manner in which the above recited aspects are attained and can be understood in detail, a more particular description of embodiments described herein, briefly summarized above, may be had by reference to the appended drawings. It is to be noted, however, that the appended drawings illustrate typical embodiments and are therefore not to be considered limiting; other equally effective embodiments are contemplated.

FIG. 1A is a schematic cross-sectional view of an oil recovery system that may incorporate the principles of the present embodiment.

FIG. 1B is a schematic cross-sectional view of the oil recovery system of FIG. 1A after a first skimmer and a second skimmer of the oil recovery system have been partially drained.

FIG. 1C is a schematic cross-sectional view of the oil recovery system of FIG. 1A after the fluid level within the first skimmer has dropped to allow a valve within the first skimmer to open to cause the second skimmer to drain into the first skimmer through an opening that is no longer blocked by the valve.

FIG. 1D is a schematic cross-sectional view of the oil recovery system after the first skimmer and second skimmer have been drained.

FIG. 2 is a flow chart of a method of recovering oil from storm water from an onshore oil processing facility using the recovery system, according to one or more embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to an oil recovery system to manage storm water runoff from an onshore oil facility. The storm water, which is ladened with oil, enters a first skimmer of the oil recovery system before entering a sump pit where the storm water is pumped to an oil recovery tank to facilitate separation of oil from the storm water. However, storm water entering the first skimmer may flow into a second skimmer by overtopping (flowing over) a weir wall that divides the first skimmer from the second skimmer. The storm water in the first and second skimmers eventually separates into a layer of oil that floats atop a layer of water. Some of the storm water within the first and second skimmers ultimately flows into the sump pit where the storm water is pumped to the oil recovery tank. However, some of the water accumulating in the first and second skimmers that has separated from the oil flows into an evaporation pond through T-shaped pipes that provide a flow path between the second skimmer and the evaporation pond. The T-shaped pipes are configured such that water, but not the oil, flows into an adjacent evaporation pond. A floating barrier may be disposed in the second skimmer to inhibit oil from reaching the T-shaped pipes. The first and second skimmers are eventually drained due to the action of the pump within the sump and the fluid connection between the sump pit and the first and second skimmers. Thus, the first and second skimmers facilitate cleaning the storm water so that a portion of the water is directed to an evaporation pond to naturally evaporate while another portion of the water is pumped to an oil recovery tank for further processing.

The presently disclosed oil recovery system may prove advantageous for a variety of reasons. For example, the skimmers of the oil recovery system are separated from the sump pit which helps avoid contaminating the evaporation pond. Additionally, the oil recovery system can handle larger volumes of storm water runoff than conventional oil separation systems which helps avoid contaminating the environment with oil when the storm water runoff exceeds the volumetric capacity of conventional oil recovery systems.

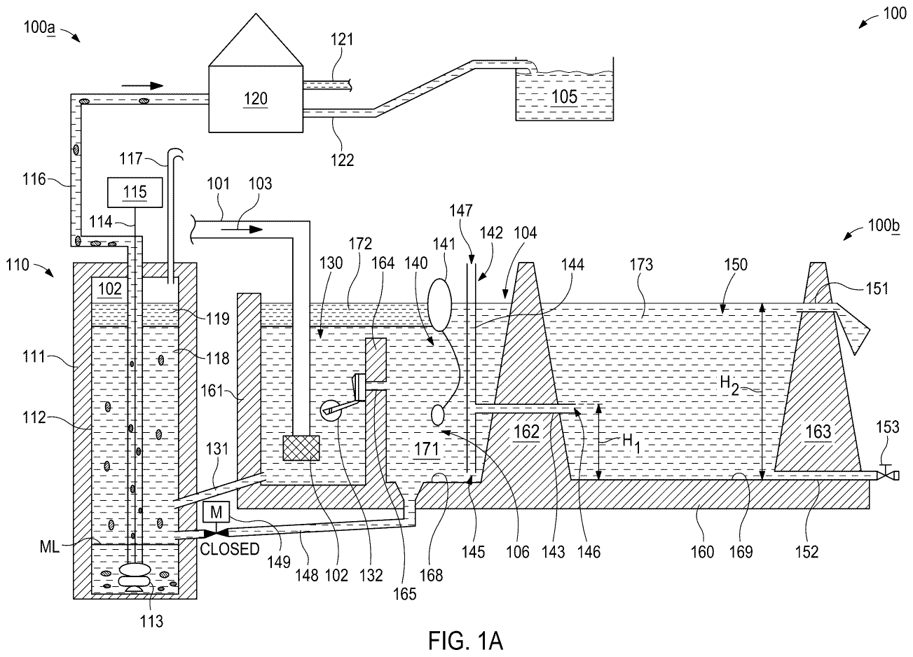

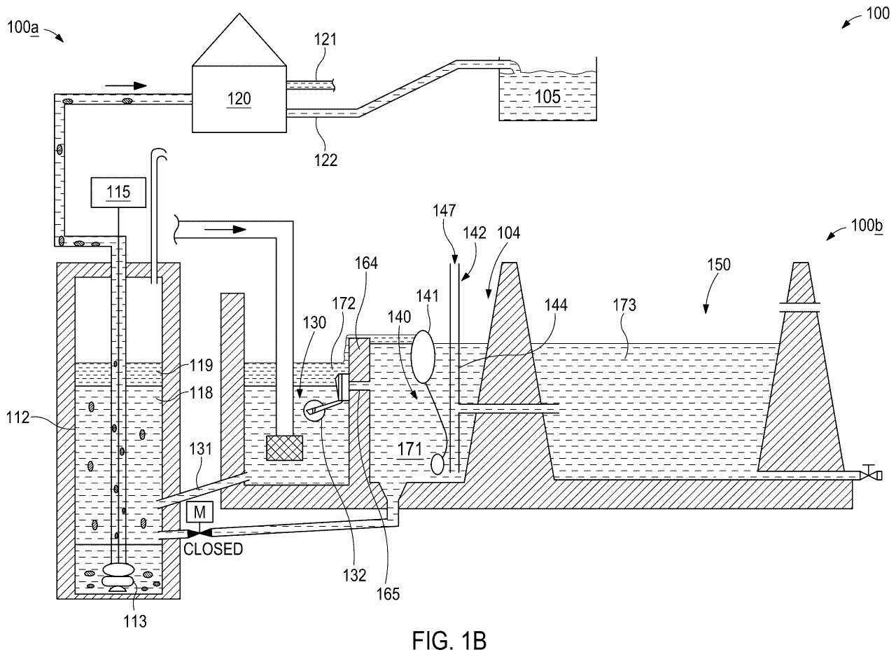

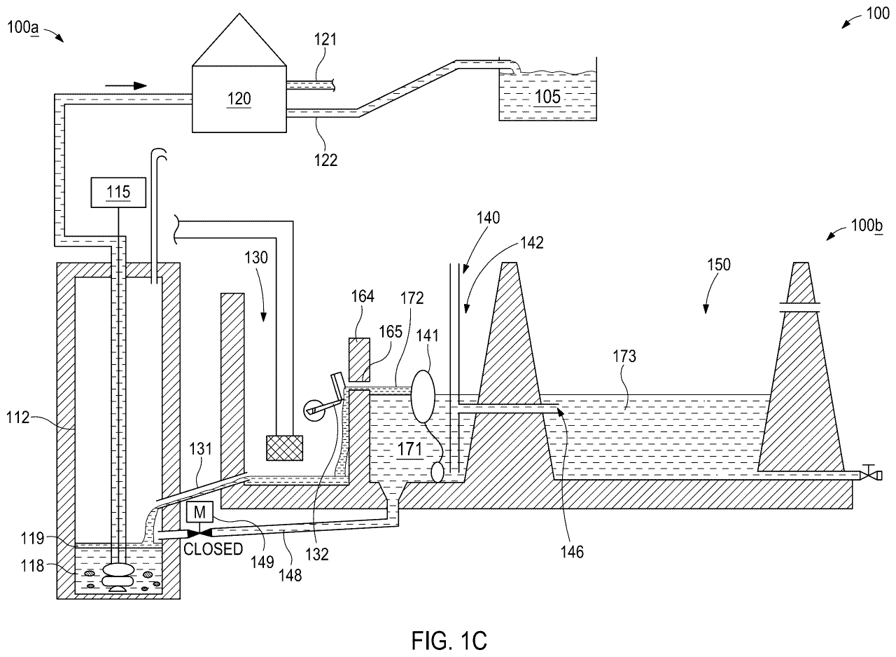

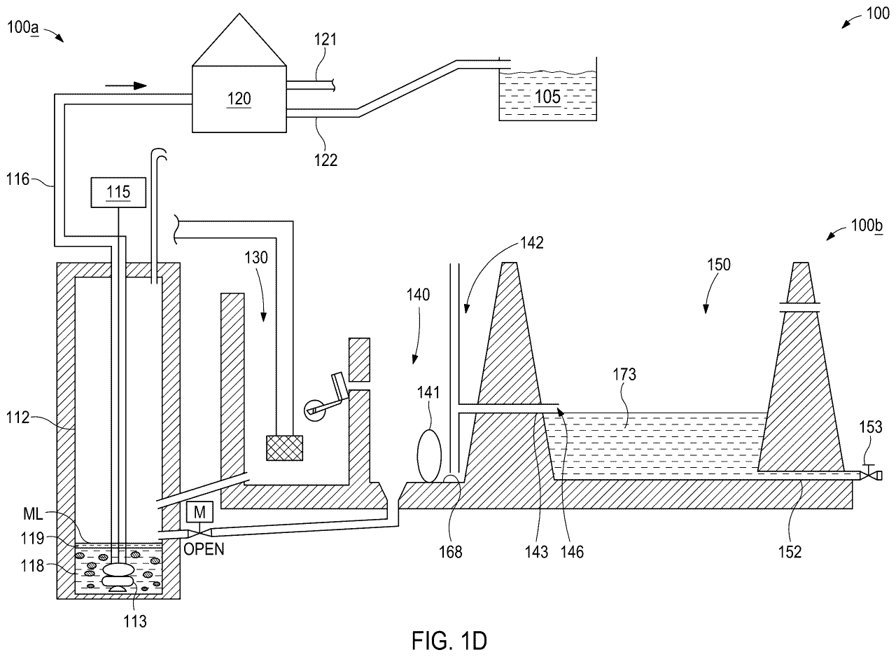

FIGS. 1A-1D illustrate a schematic partial cross-sectional view of an example recovery system 100 for recovering oil mixed with storm water. The recovery system 100 may be part of or located near an onshore oil facility, such as a refinery. The onshore facility includes a storm water system, such as a storm water sewer. Oil at the onshore facility may be washed into the storm water system during or after a precipitation event (e.g., rain, snow, sleet, ice, etc.). Thus, storm water 103 that is ladened with oil is directed to the recovery system 100 where the oil is separated from the water. The separated oil can thereafter be processed at the onshore oil facility. Thus, the oil is prevented from entering the environment and is instead processed at the onshore oil facility.

As shown in FIG. 1A, the recovery system 100 includes a sump 110, an oil recovery tank 120, a first skimmer 130, a second skimmer 140, and an evaporation pond 150. The sump 110 and oil recovery tank 120 are part of a recovery portion 100a of the recovery system 100, while the first skimmer 130, the second skimmer 140, and the evaporation pond 150 are part of a separation portion 100b of the recovery system 100.

The sump 110 includes one or more walls 111 that define a sump pit 112. FIG. 1A shows a column of fluid (e.g., storm water runoff from the onshore facility) within the sump pit 112. The column of fluid includes oil 119 that has separated from water 118. A pump 113 is disposed in a lower portion of the sump pit 112. The pump 113 is selectively operated to pump the fluid within the sump pit 112 to the oil recovery tank 120 through a pipeline 116. In some embodiments, the pump 113 may be an electrical submersible pump that includes a rotor and a stator. The rotor may be connected to one end of a shaft rod 114, and the rotor may be driven by a motor 115 connected to the shaft rod 114. Rotation of the rotor relative to the stator pumps fluid from the sump pit 112 to the oil recovery tank 120 through pipeline 116. In some embodiments, the sump 110 includes more than one pump 113 for redundancy, such as two pumps as shown in FIG. 1A. For example, one pump 113 may be active while the other pump 113 is on standby until needed. In some embodiments, the pumps are the same, such as being a vertically suspended API 610 centrifugal pump.

In some embodiments, the sump 110 includes a vent 117 in communication with the sump pit 112. The vent 117 allows the air pressure in the sump pit 112 to equalize with the atmosphere as the fluid level changes within the sump pit 112.

The fluid directed to the oil recovery tank 120 is treated to separate the oil from the water. In some embodiments, the oil is separated from the water within the oil recovery tank 120 by allowing sufficient time for the oil to naturally separate itself from the water based on polarity and/or differences in density. One or more treatment additives may be added to the fluid within the oil recovery tank 120 to facilitate the separating the oil from the water. The oil recovered from the fluid may be directed for further processing at the onshore facility via a first outlet 121. The water recovered from the fluid may be directed to one or more evaporation ponds 105 via a second outlet 122.

As noted above, the separation portion 100b includes the first skimmer 130, the second skimmer 140, and the evaporation pond 150. In some embodiments, the separation portion 100b may be a concrete and/or earthen structure 160 that includes or otherwise defines each of the first skimmer 130, the second skimmer 140, and the evaporation pond 150. In some embodiments, the first skimmer 130 and the second skimmer 140 may be part of one concrete and/or earthen structure while the evaporation pond 150 may form part of a separate concrete and/or earthen structure.

FIG. 1A shows the separation portion 100b after or during a precipitation event, with the first skimmer 130 and the second skimmer 140 containing storm water that has separated into a layer of water 171 and a layer of oil 172 that floats on the water 171. Storm water 103 ladened with oil from the onshore facility is directed to the first skimmer 130 via at least one pipeline 101. Each pipeline 101 may include a vortex breaker 102 to mitigate or prevent vortices (e.g., whirlpools) from forming within the first skimmer 130 as the storm water 103 flows into the first skimmer 130.

The first skimmer 130 and the second skimmer 140 each provide or encompass a region of the structure 160 in which fluid (e.g., storm water runoff) can accumulate. The first skimmer 130 is bounded on one side by a first wall 161 (e.g., an end wall) of the structure 160 and is bounded on the other side by a separator wall 164 (e.g., a weir wall) of the structure 160. The second skimmer 140 is bounded on one end by the separator wall 164 and is bounded on the other end by a second wall 162 of the structure 160.

The first skimmer 130 and the second skimmer 140 are generally separated from one another by the separator wall 164. The separator wall 164 includes one or more openings 165 that extend from the first skimmer 130 to the second skimmer 140. In some embodiments, a valve 132 is disposed in the first skimmer 130 to control fluid communication between the first skimmer 130 and the second skimmer 140 through the opening(s) 165. For example, the valve 132 may be a one-way valve to prevent fluid from flowing into the second skimmer 140 from the first skimmer 130 through the opening(s) 165 while allowing fluid to flow into the first skimmer 130 from the second skimmer 140.

In some embodiments, and as shown in FIG. 1A, the valve 132 is a float clapet valve that closes the opening 165 when the fluid level within the first skimmer 130 exceeds a threshold level, and opens the valve 132 to unblock the opening 165 (see FIG. 1C) when the fluid level drops below the threshold level. For example, the float clapet valve may have a balloon that controls whether the valve is open or closed based on the fluid level within the first skimmer 130. While only one valve 132 and opening 165 are shown in the Figures, the recovery system 100 may have a plurality of openings 165 that are each controlled by separate valves 132.

During or after (e.g., during melting of ice, sleet, snow) a precipitation event, storm water 103 exiting the pipeline 101 fills the first skimmer 130 until the fluid level reaches the top of the separator wall 164. Continued influx of the storm water 103 into the first skimmer 130 causes the storm water to exceed the height of the separator wall 164 and overtop (flow over) the separator wall 164 and flow into the second skimmer 140.

The first skimmer 130 is in fluid communication with the sump pit 112 via a first drain 131. The first drain 131 is a flow path between the first skimmer 130 and the sump pit 112 to allow storm water in the first skimmer 130 to flow into the sump pit 112 under the influence of gravity. The first drain 131 may be a pipeline or a channel, and may be oriented at a slope to achieve a desired pressure head between the inlet and outlet of the first drain 131.

The second skimmer 140 is fluidly connected to the sump pit 112 by a second drain 148 that allows the storm water to flow out the bottom of the second skimmer 140 and into the sump pit 112 under the influence of gravity. The second drain 148 may also have a slope selected to achieve a desired pressure head between the inlet and the outlet of the second drain 148. A valve 149 may be positioned along (arranged within) the second drain 148 to selectively allow or disallow (prevent) fluid communication between the sump pit 112 and the second skimmer 140. In some embodiments, as illustrated, the outlet of the second drain 148 may be located closer to the bottom of the sump pit 112 than the outlet of the first drain 131. The valve 149 may be opened to allow fluid to drain from the second skimmer 140. In some embodiments, the valve 149 is opened to facilitate emptying the second skimmer 140 so that the second skimmer 140 can be undergo maintenance and/or repairs.

The second skimmer 140 includes at least one T-shaped pipe 142 that fluidly couples the second skimmer 140 to the evaporation pond 150. Each T-shaped pipe 142 includes a first portion 143 (e.g., stem of the T) extending substantially horizontally and a second portion 144 (e.g., top of the T) that intersects the first portion 143 and extends substantially vertically. As shown, the first portion 143 is at least partially embedded in (extends through) the second wall 162 of the structure 160. The second portion 144 includes an inlet 145 at one end that is in fluid communication an open end 147 located at the other end of the second portion 144. The first portion 143 includes an outlet 146 that is in fluid communication with the inlet 145 and the open end 147.

FIG. 1A shows the T-shaped pipe 142 partially submerged in the water 171, with the inlet 145 submerged in the water 171 while the open end 147 is located above the water 171. A portion of the water 171 in the second skimmer 140 flows into the inlet 145 and exits the outlet 146 into the evaporation pond 150. The outlet 146 of the T-shaped pipe 142 is located at a first elevation (e.g., height) H1 relative to a floor 169 of the evaporation pond 150. The open end 147 facilitates fluid flow through the T-shaped pipe 142 to transfer water 171 from the second skimmer 140 to the evaporation pond 150. Flow of the portion of the water 171 from the second skimmer 140 to the evaporation pond 150 is passive since a pump is not connected to the inlet 145 to actively pump the water through the T-shaped pipe 142 into the evaporation pond 150. In some embodiments, the outlet 146 may include a one way valve to prevent backflow of the water in the evaporation pond 150 into the second skimmer 140.

The second portion 144 is sized to position the inlet 145 of the second portion 144 close to a bottom surface 168 (e.g., floor) of the structure 160 partially defining the second skimmer 140 to facilitate the flow of water 171 into the inlet 145 with minimal to no flow of oil 172 into the inlet 145. For example, the inlet 145 may be positioned within a few feet, such as within 1 foot or within a few inches, of the bottom surface 168. In some embodiments, the second portion 144 is sized to position the open end 147 at the same elevation (height) as the top of the second wall 162 or above the top of the second wall 162. While one T-shaped pipe 142 is shown, the recovery system 100 may include a plurality of T-shaped pipes 142.

In some embodiments, the second skimmer 140 includes a floating barrier 141 to prevent and/or inhibit the oil 172 from reaching the T-shaped pipes 142. In other words, the floating barrier 141 shields a protected area 104 of the second skimmer 140 from the oil layer 172 to help prevent oil from reaching the T-shaped pipes 142 and/or the evaporation pond 150. The floating barrier 141 is partially submerged to inhibit the oil 172 from flowing underneath or over the top of the floating barrier 141. Water passes underneath the floating barrier 141 to reach the protected area 104. For example, FIG. 1A shows a flow path 106 between the bottom surface 168 and an end (e.g., weights) of the floating barrier 141 that allows water to flow to the protected area 104 and into the T-shaped pipe 142.

The floating barrier 141 may also be selected to accommodate waves and/or wind conditions to inhibit the oil 172 from reaching the protected area 104. To accomplish this, the floating barrier 141 includes one or more bladders and/or balloons to provide buoyancy. The vertical position of the floating barrier 141 in the second skimmer 140 changes as the fluid level within the second skimmer 140 changes. In some embodiments, the floating barrier 141 may be a floating boom with one or more balloons. For example, the floating boom may be U-shape, V-shape, or straight line, depending on factors such as oil layer size, flow rate and skimmer type.

In some embodiments, the inlet 145 of the T-shaped pipe 142 is positioned at an elevation relative to the bottom surface 168 based on the lowest fluid level that the floating barrier 141 can satisfactorily prevent oil 172 from reaching the protected area 104. In some embodiments, some water 173 in the evaporation pond 150 may backflow into the second skimmer 140 through the T-shaped pipe 142 as the first and second skimmers 130, 140 are drained. The backflow of water 173 helps prevent oil from entering into the protected area 104 through the flow path 106 as the skimmers 130, 140 are drained.

The evaporation pond 150 is sized to accommodate a volume of water 173 that is relatively cleaned of oil. In other words, most, and some cases substantially all, of the oil of the storm water 103 is prevented from entering the evaporation pond 150 and is instead diverted to the sump pit 112. Water 171 flows into the evaporation pond 150 from the second skimmer 140 through the T-shaped pipes 142. The water 173 accumulated within the evaporation pond 150 is allowed to evaporate over time. Residual chemicals and/or materials, including residual oil, in the water 173 that do not evaporate may be removed once enough water 173 has evaporated. For example, the residual chemicals and/or materials may be removed during the dry season when little precipitation is expected.

The evaporation pond 150 includes one or more overflow drains 151 that extend through a third wall 163 of the structure 160 to provide a boundary for the evaporation pond 150. The overflow drains 151 are disposed at a second elevation H2 relative to the floor 169 of the evaporation pond 150. The second elevation H2 exceeds the first elevation H1. However, the second elevation H2 is less than the elevation of the first wall 161 to inhibit the fluid level within the separation portion 100b from overtopping (overflowing) the walls 161, 162, and 163 of the structure 160. The water exiting the overflow drains 151 may flow to another evaporation pond or to another area, such as an open area or a percolation area.

The evaporation pond 150 may also include one or more lower drains 152 that extend through the third wall 163 at an elevation close to or at the same elevation as the floor 169. Each lower drain 152 may include a valve 153 that is selectively actuated to allow the water 173 to drain out of the evaporation pond 150. In some applications, the lower drain 152 may drain to a percolation area.

In some embodiments, and as shown in FIG. 1A, the evaporation pond 150 is bounded at one end by the second wall 162 and bounded at the other end by the third wall 163. In other words, the second skimmer 140 and the evaporation pond 150 share the same wall 162. In some embodiments, the evaporation pond 150 and the second skimmer 140 do not share the same wall and may even be part of separate structures. In these embodiments, the first portion 143 of the T-shaped pipe 142 may extend between the second skimmer 140 and the evaporation pond 150 or may be fluidly coupled to the evaporation pond 150 by a pipeline to allow the water 171 in the second skimmer 140 to flow into the evaporation pond 150.

Additionally, while only one evaporation pond 150 is shown, the recovery system 150 may include a plurality of evaporation ponds 150 arranged in series to accommodate surge volumes of storm water to maximize the amount of storm water that is skimmed of oil. For example, the structure 160 may include a plurality of evaporation ponds 150.

FIGS. 1A-1D illustrate a progressive operating sequence of skimming the oil 172 from the water 171 using the recovery system 100. FIG. 1A illustrates the fluid level within the recovery system 100 after a precipitation event sufficient to cause water to exit the overflow drains of the evaporation pond 150. To fill the recovery system 100, storm water 103 ladened with oil from the onshore facility is directed to the first skimmer 130 via the at least one pipeline 101. The sump pit 112, the first skimmer 130, the second skimmer 140, and evaporation pond 150 may have been empty or substantially empty prior to the precipitation event.

A portion of the storm water 103 entering the first skimmer 130 through the pipeline 101 flows into the sump pit 112 of the sump 110 through the first drain 131. Eventually, enough storm water 103 has flowed into the sump pit 112 to cause the fluid level to rise in the first skimmer 130. The fluid level within the first skimmer 130 eventually reaches a level sufficient to cause the float clapet valve 132 to close, thereby closing the opening 165. The storm water 103 continues to fill the first skimmer 130 and the sump pit 112 until the fluid level reaches the top of the separator wall 164.

Continued influx of the storm water 103 into the first skimmer 130 causes the storm water to overtop (overflow) the separator wall 164 and flow into the second skimmer 140. The storm water 103 in the first skimmer 130 begins to separate into the layer of oil 172 on top of the water 171 as the fluid level rises within the first skimmer 130. Thus, oil 172 may first flow into the second skimmer 140 over the separator wall 164 before the water 171. The storm water 103 that flows into the sump pit 112 similarly separates into water 118 and oil 119. The fluid level within the second skimmer 140 may eventually reach the top of the separator wall 164 allowing the fluid level within the first skimmer 130, the second skimmer 140, and the sump pit 112 to continue to rise.

The floating barrier 141 shields the protected area 104 from the oil 172 as the second skimmer 140 fills. For example, the flow path 106 underneath the floating barrier 141 may not form until the fluid level within the second skimmer 140 reaches a certain level, which may be selected to ensure sufficient dwell time of the storm water 103 for the layer of water 171 to form so that oil 172 does not flow through the flow path 106. In some operations, the valve 149 is opened to drain the second skimmer 140 to facilitate maintenance and/or repair of the second skimmer 140. Thus, some amount (e.g., level) of fluid may already be present in the second skimmer 140 prior to the precipitation event. The floating barrier 141 floats on the fluid already present within the second skimmer 140 prior to the precipitation event, which prevents the oil 172 flowing into the second skimmer 140 from the storm water 103 from reaching the protected area 104. In some embodiments, a minimum amount (e.g., minimum level) of fluid may be maintained in the second skimmer 140, outside of periods of maintenance of repair, to float the floating barrier 140 such that the protected region 104 is shielded from oil 172. The fluid level within the second skimmer 140 eventually fills to a level that promotes flow of the water 171 through the T-shaped pipe 142 to the evaporation pond 150.

The valve 149 is closed as the second skimmer 140 fills. In some embodiments, the volumetric flow rate of the storm water 103 entering the recovery system 100 may temporarily exceed the flow rate of water from the second skimmer 140 to the evaporation pond 150. Therefore, the fluid level within the first skimmer 130, the second skimmer 140, and/or sump pit 112 may temporarily exceed the fluid level within the evaporation pond 150.

The volume of the storm water 103 entering the recovery system 100 may cause the fluid within the recovery system 100 to rise to the level shown in FIG. 1A where some of the water 173 in the evaporation pond 150 flows through the overflow drains 151 and escapes the evaporation pond 150. However, in some applications, the precipitation event may not generate enough storm water 103 to reach the overflow drains 151.

The pump 113 may be activated, such as by starting the motor 115, once the fluid level within the sump pit 112 exceeds a minimum level shown by line ML. The minimum level ML is selected to avoid running the pump 113 dry. In some embodiments, the pump 113 is not activated until the pump 113 reaches a desired fill level, such as a maximum fill level shown in FIG. 1A. In at least one embodiment, the maximum fill level within the sump pit 112 may be the same level (height) as the overflow drains 151. The pump 113 will pump the fluid within the sump pit 112 into the oil recovery tank 120 until stopped by the operator or until the level reaches the minimum level ML. The pump 113 may be restarted once the fluid level exceeds the minimum level ML.

FIG. 1B shows the recovery system 100 after running the pump 113 for a period of time. The precipitation event may have ceased during, before, or after the operation of the pump 113. As shown, the fluid level within the sump pit 112 and the separation portion 100b has dropped from the level shown in FIG. 1A due to operation of the pump 113.

In some embodiments, some water 173 within the evaporation pond 150 is able to back flow into the second skimmer 140 as the fluid level within the skimmers 130, 140 drops. Fluid within the first skimmer 130 flows into the sump pit 112 through the first drain 131 as the pump 113 pumps fluid to the oil recovery tank 120. Eventually the fluid level within the first skimmer 130 recedes below the top of the separator wall 164. The separator wall 164 and the closed valve 132, however, temporarily cause the fluid level in the second skimmer 140 to exceed the fluid level within the first skimmer 130 as shown in FIG. 1B. A portion of the oil 172 in the second skimmer 140 is shown flowing into the first skimmer 130 over the top of the separator wall 164 as fluid level within the second skimmer 140 decreases to equalize with the height of the separator wall 164.

Continued operation of the pump 113 causes the fluid level within the first skimmer 130 to drop below the threshold value (height) of the valve 132, thereby causing the valve 132 to open. A portion of the water 171 and oil 172 within the second skimmer 140 above the opening 165 flows into the first skimmer 130 through the unblocked opening 165 and then flows into the sump pit 112 through the first drain 131. Water may also backflow from the evaporation pond 150 to the second skimmer 140 through the T-shaped pipe 142. The floating barrier 141 continues to shield the protected area 104 as the fluid level within the second skimmer 140 drops.

FIG. 1C illustrates the recovery system 100 after the fluid level within the second skimmer 140 has receded to the opening 165 through the separator wall 164. A portion of the oil 172 is shown flowing into the first skimmer 130 through the opening 165 and into the sump pit 112 through the first drain 131.

The fluid level within the second skimmer 140 drops until the fluid level is below the opening 165 such that fluid no longer flows from the second skimmer 140 into the first skimmer 130. The valve 149 may be opened to allow fluid to drain out of the bottom of the second skimmer 140 into the sump pit 112 through the second drain 148. For example, the valve 149 may be opened once the fluid level within the second skimmer 140 has dropped sufficiently to stop the flow of fluid, such as the oil 172, into the first skimmer 130 through the opening 165. Additionally, the fluid level within the sump pit 112, in addition to the fluid level in the second skimmer 140, may also be considered when opening the valve 149, such as opening the valve 149 when the fluid level in the sump pit 112 is below the outlet of the second drain 148. Once the valve 149 is opened, fluid drains out of the second skimmer 140 and into the sump pit 112. In some embodiments, the valve 149 is operated remotely, such as being operated from a control room of the onshore facility. The pump 113 may be operated to pump the storm water into the oil recovery tank 120 as the second skimmer 140 is drained.

In some embodiments, the valve 149 may be opened to drain the second skimmer 140 so that the oil 172 remaining in the second skimmer 140 is directed to the sump pit 112 to allow the oil 172 to be pumped to the oil recovery tank 120. In some embodiments, the valve 149 is opened periodically to empty the second skimmer 140 to facilitate maintenance and/or repair the second skimmer 140. Thus, some storm water 103 entering the separation portion 100a may remain within the second skimmer 140 between successive precipitation events.

Some water within the evaporation pond 150 may backflow into the second skimmer 140 until the fluid level within the evaporation pond 150 drops below the outlet 146 of the T-shaped pipe 142.

FIG. 1D illustrates the recovery system 100 after fully draining (e.g., emptying) the first skimmer 130 and the second skimmer 140. As shown, the floating barrier 141 has landed on the bottom surface 168. The water level within the evaporation pond 150 is below the outlet 146 of the T-shaped pipe 142, which prevents backflow of the water 173 into the second skimmer 140. The water 173 remaining in the evaporation pond 150 is thereafter allowed to evaporate to empty the evaporation pond 150, at least until another precipitation event occurs, or could be drained via the lower drain(s) 152 by opening the corresponding valve 153. FIG. 1D also shows that the fluid (water 118, oil 119) within the sump pit 112 is at the minimum level ML. As shown, fluid is not being pumped through the pipeline 116 by the pump(s) 113 and water and oil are not flowing out of the outlets 121, 122.

The fluid that drains into the sump pit 112 during the draining of the separation portion 100b is pumped to the oil recovery tank 120 where the oil is sent back to the onshore facility through the first outlet 121 and the water is directed to one or more additional evaporation ponds 105 through the second outlet 122. The storm water within the oil recovery tank 120 may undergo a chemical treatment to facilitate separation of the oil from the water.

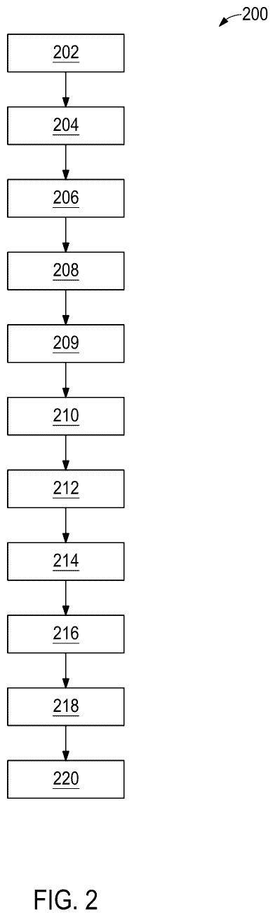

FIG. 2 illustrates an exemplary method 200 of recovering oil from storm water from an onshore oil processing facility using the recovery system 100.

At operation 202, storm water 103 from the storm water system of the onshore facility is conveyed into the first skimmer 130 through the pipeline 101. The storm water 103 is ladened with oil. The storm water 103 may be conveyed by gravity (e.g., passively) or by one or more pumps through the pipeline 101 into the first skimmer 130. The fluid level within the first skimmer 130 eventually rises to a level that causes the valve 132 to close to block the opening 165.

At operation 204, a portion of the storm water 103 entering the first skimmer 130 is conveyed into the sump pit 112 through the first drain 131. The portion of the storm water is conveyed by gravity to the difference in elevation of the inlet and outlet of the first drain 131. Operation 204 may occur simultaneously with operation 202.

At operation 206, the pump 113 arranged in the sump pit 112 is activated once the fluid level within the sump pit 112 reaches a predetermined fluid level to pump the fluid within the sump pit 112 to the oil recovery tank 120. The pump 113 may be deactivated if the fluid level decreases to the minimum level. In some embodiments, the pump 113 may be reactivated once the fluid level exceeds the minimum level. Operation 206 may occur simultaneously with operations 202, 204.

At operation 208, the storm water within the first skimmer 130 overflows into the second skimmer 140 by overtopping the separator wall 164. Some oil may have formed an oil layer 172 by the time that the storm water overtops the separator wall 164. Operation 208 may occur during operations 202, 204, and 206.

At operation 209, the oil 172 in the storm water 103 within the skimmers 130, 140 is allowed to separate from the water 173. Operation 209 may occur during operations 202, 204, 206, and 208.

At operation 210, the fluid level within the second skimmer 140 reaches a fluid level that hydrodynamically conveys water 171 through the T-shaped pipes 142 into the evaporation pond 150. The T-shaped pipes 142 are arranged to inhibit oil 172 from entering the evaporation pond 150. In some embodiments, the T-shaped pipes 142 are shielded from the oil 172 by the floating barrier 141. Operation 210 may occur during operations 202, 204, 206, 208, and 209.

At operation 212, the storm water pumped into the oil recovery tank 120 is separated into oil and water. The storm water may be chemically treated to separate the oil and/or to decontaminate the water. The oil is sent back to the onshore facility through the first outlet 121 and the water is directed to the evaporation pond 105 through the second outlet. Operation 212 may occur during operations 202, 204, 206, 208, 209, and 210.

The influx of storm water 103 eventually abates (e.g., rain stops) or reduces to an amount that the pump 113 can begin to lower the fluid level within the recovery system 100 during operation 206. The first and second skimmers 130, 140 may then be drained of storm water while inhibiting oil from entering the evaporation pond 150.

At operation 214, the fluid within the first skimmer 130 and second skimmer 140 is drained by action of the pump 113 while the valve 149 is closed. In some embodiments, a portion of the water 173 in the evaporation pond 150 back flows into the second skimmer 140 as the first and second skimmers 130, 140 are drained. The fluid level within the first skimmer 130 eventually drops below the fluid level within the second skimmer 140 due to the closed valve 132 and the separator wall 164 as shown in FIG. 1B. As a result, storm water in the second skimmer 140, such as oil 172, flows into the first skimmer 130 until the level within the second skimmer 140 equalizes with the top of the separator wall 164. Partially draining the second skimmer 140 into the first skimmer 130 over the top of the separator wall 164 reduces the amount of oil 172 within the second skimmer 140 that needs to be drained out of the bottom of the second skimmer 140, which also helps avoid oil from entering the protected area 104 as the fluid level within the second skimmer 140 approaches empty. The closed valve 149 prevents further draining of the second skimmer 140 until the valve 132 are opened. The first skimmer 130, however, continues to be drained via the first drain 131. The pump 113 continues to operate to pump storm water within the sump pit 112 to the oil recovery tank 120, where the oil is separated from the water.

At operation 216, the fluid level within the first skimmer 130 eventually reaches the threshold for opening the valve 132, which causes a portion of the storm water within the second skimmer 140 above the opening 165 to drain into the first skimmer 130 through the opening 165. The storm water draining into the first skimmer 130 through the opening 165 drains into the sump pit 112 through the first drain 131, where the water is thereafter pumped to the oil recovery tank 120. In some embodiments, water 173 backflows into the second skimmer 140 through the T-shaped pipes during operation 216. As shown in FIG. 1C, a portion of the oil 172 within the second skimmer 140 flows into the first skimmer 130 through the opening 165, which further reduces the amount of oil 172 within the second skimmer 140. The fluid level within the second skimmer 140 continues to drop until storm water within the second skimmer 140 no longer flows through the opening 165. The fluid from the second skimmer 140 that flows into the first skimmer 130 drains into the sump pit 112 via the first drain 131. The pump 113 is stopped once the fluid level within the sump pit 112 reaches the minimum level ML.

Operation 218 is optional. At operation 218, the valve 149 is opened to drain the remaining fluid within the second skimmer 140 into the sump pit 112 through the second drain 148. For example, the valve 149 may be opened to facilitate maintenance and/or repair of the second skimmer 140. In some embodiments, water 173 in the evaporation pond 150 backflows into the second skimmer 140 as the second skimmer 140 is drained until the fluid level within the evaporation pond 150 drops sufficiently to stop flow through the T-shaped pipe 142. In other words, backflow of the water 173 stops once the fluid level within the evaporation pond 150 drops below the outlet 146. The pump 113 may continue to operate to pump storm water within the sump pit 112 to the oil recovery tank 120 during operation 218. The pump 113 is stopped once the second skimmer 140 is drained and the fluid level within the sump pit 112 reaches the minimum level ML. Operation 218 may occur after the fluid level within the second skimmer 140 drops sufficiently to stop flow through the opening 165.

At operation 220, the water 173 remaining in the evaporation pond 150 after the first and second skimmers 130, 140 are drained is allowed to evaporate since the evaporation pond 150 is exposed to the sun and wind. In some embodiments, the water level within the evaporation pond 150 can be lowered by opening the valve 153 of the lower drain 152, such as draining any residual water that is mixed with particulate matter that has settled on the bottom of the evaporation pond 150.

Method 200 repeats when a new precipitation even occurs. Additionally, multiple precipitation events, such as periodic rain showers, may occur during method 200. In other words, method 200 may occur during multiple precipitation events, with each new precipitation event causing additional storm water 103 to flow into the recovery system 200 before all the storm water from a prior storm event has been processed by the recovery system 200.

Embodiments disclosed herein include:
A. A method for recovering oil from storm water derived from an oil processing facility comprises conveying storm water comprising water ladened with oil to a first oil skimmer. The method further comprises conveying a portion of the storm water from the first oil skimmer into a sump pit in fluid communication with the first oil skimmer. The method further comprises pumping the portion of the storm water from the sump pit to an oil recovery tank. The method further comprises overflowing the storm water from the first oil skimmer to a second oil skimmer over a separator wall arranged between the first oil skimmer and the second oil skimmer. The method further comprises allowing the oil to separate from the water. The method further comprises conveying water accumulated in the second oil skimmer to an evaporation pond through one or more T-shaped pipes.
B. An oil recovery system comprises a first oil skimmer, a sump pit, one or more pumps, a second oil skimmer, and an evaporation pond. The first oil skimmer receives storm water comprising water ladened with oil from an oil processing facility. The sump pit in fluid communication with the first oil skimmer through a first drain, wherein the sump pit receives a portion of the storm water from the first oil skimmer. The one or more pumps are arranged in the sump pit and operable to pump the portion of the storm water from the sump pit to an oil recovery tank. The second oil skimmer is separated from the first oil skimmer by a separator wall, wherein the second skimmer receives a portion of the storm water from the first oil skimmer when the storm water overflows the separator wall. The evaporation pond is in fluid communication with the second oil skimmer to receive a portion of the water accumulated in the second oil skimmer and that has separated from the oil.
C. An oil recovery system comprises an evaporation pond, a structure, a valve, and a T-shaped pipe. The structure defining a first skimmer and a second skimmer, the structure including a weir wall dividing the first skimmer from the second skimmer, and the weir wall defining an opening extending between the first and second skimmers. The valve is disposed in the first skimmer at the opening, the valve being closed to block fluid communication between the first and second skimmers through the opening when a fluid level within the first skimmer is at or above a threshold level, and being opened to allow fluid communication between the first and second skimmers through the opening when the fluid level is below the threshold level. The T-shaped pipe is partially disposed within the second skimmer to fluidly couple the second skimmer to the evaporation pond, the T-shaped pipe including a first portion and a second portion that intersects the first portion, the first portion including an inlet and an open end and the second portion including an outlet.

Each of embodiments A, B, and C may have one or more of the following additional elements in any combination: Element 1: wherein the one or more T-shaped pipes are arranged within the second oil skimmer and facilitate fluid communication between the second oil skimmer and the evaporation pond, and wherein conveying the portion of the water from the storm water to the evaporation pond through each T-shaped pipe comprises: drawing the water into an inlet of the T-shaped pipe positioned above a floor of the second oil skimmer; and flowing the water through an outlet of the T-shaped pipe in communication with the evaporation pond, wherein the inlet and the outlet are in communication with an open end of the T-shaped pipe positioned above the storm water within the second skimmer. Element 2: preventing oil floating on a surface of the water in the second oil skimmer from approaching the one or more T-shaped pipes using a floating barrier within the second skimmer. Element 3: pumping the portion of the storm water from the sump pit to the oil recovery tank comprises: activating one or more pumps arranged within the sump pit once the portion of the storm water within the sump pit reaches a predetermined level; and deactivating the one or more pumps when the portion of the storm water descends to a minimum level. Element 4: the evaporation pond is a first evaporation pond, and the method further comprises: separating water from oil in the oil recovery tank using a chemical treatment; directing the water separated from the oil to a second evaporation pond; and recovering and conveying the oil separated from the water back to the oil processing facility. Element 5: draining the storm water in the first skimmer into the sump pit until a fluid level within the first skimmer drops to a level that causes a valve to unblock an opening through the separator wall; and draining a portion of the storm water in the second oil skimmer into to the first oil skimmer through the opening in the separator wall.

Element 6: one or more T-shaped pipes arranged within the second oil skimmer to facilitate fluid communication between the second oil skimmer and the evaporation pond. Element 7: a floating barrier arranged to prevent oil floating on a surface of the water in the second oil skimmer from approaching the one or more T-shaped pipes. Element 8: the one or more pumps are two pumps. Element 9: a float clapet valve disposed in the first skimmer and configured to block an opening through the separator wall when the storm water within the first skimmer reaches a fluid level threshold, and unblock the opening when the storm water within the first skimmer descends below the fluid level threshold. Element 10: a second drain fluidly coupling the second oil skimmer with the sump pit; and a valve arranged within the second drain and operable to control flow of the storm water from the second oil skimmer into the sump pit through the drain. Element 11: the first skimmer, the second skimmer, and the evaporation pond are part of the same structure.

Element 12: the structure defines the evaporation pond and the second portion of the T-shaped pipe extends through a first wall of the structure dividing the second skimmer from the evaporation pond. Element 13: the evaporation pond is disposed between the first wall and a second wall of the structure. Element 14: an overflow drain formed through the second wall at a first elevation to inhibit overflowing of the second wall, and wherein the outlet of the T-shaped pipe is positioned within the evaporation pond at second elevation that is less than the first elevation. Element 15: a floating barrier disposed in the second skimmer to inhibit oil floating on top of water within the second skimmer from reaching the T-shaped pipe. Element 16: a sump pit; a first drain extending from the first skimmer to the sump pit; a second drain extending from the second skimmer to the sump pit; and a valve configured to selectively control fluid flow through the second drain. Element 17: the evaporation pond is a first evaporation pond, and the oil recovery system further comprises an oil recovery tank configured to receive fluid from the sump pit, wherein oil is separated from water within the oil recovery tank, the oil is sent to an onshore oil facility through a first outlet of the oil recovery tank, and the water is sent to a second evaporation pond through a second outlet of the oil recovery tank.

By way of non-limiting example, exemplary combinations applicable to A, B, and C include: Element 1 with Element 2; Element 12 with Element 13, Element 13 with Element 14, and Element 16 with Element 17.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method for recovering oil from storm water derived from an oil processing facility, the method comprising:
conveying storm water comprising water ladened with oil to a first oil skimmer;
conveying a portion of the storm water from the first oil skimmer into a sump pit in fluid communication with the first oil skimmer;
pumping the portion of the storm water from the sump pit to an oil recovery tank;
overflowing the storm water from the first oil skimmer to a second oil skimmer over a separator wall arranged between the first oil skimmer and the second oil skimmer;
allowing the oil to separate from the water; and
conveying water accumulated in the second oil skimmer to an evaporation pond through one or more T-shaped pipes.

2. The method of claim 1, wherein the one or more T-shaped pipes are arranged within the second oil skimmer and facilitate fluid communication between the second oil skimmer and the evaporation pond, and wherein conveying the portion of the water from the storm water to the evaporation pond through each T-shaped pipe comprises:
drawing the water into an inlet of the T-shaped pipe positioned above a floor of the second oil skimmer; and
flowing the water through an outlet of the T-shaped pipe in communication with the evaporation pond, wherein the inlet and the outlet are in communication with an open end of the T-shaped pipe positioned above the storm water within the second skimmer.

3. The method of claim 2, further comprising preventing oil floating on a surface of the water in the second oil skimmer from approaching the one or more T-shaped pipes using a floating barrier within the second skimmer.

4. The method of claim 1, wherein pumping the portion of the storm water from the sump pit to the oil recovery tank comprises:
activating one or more pumps arranged within the sump pit once the portion of the storm water within the sump pit reaches a predetermined level; and
deactivating the one or more pumps when the portion of the storm water descends to a minimum level.

5. The method of claim 1, wherein the evaporation pond is a first evaporation pond, and the method further comprises:
separating water from oil in the oil recovery tank using a chemical treatment;
directing the water separated from the oil to a second evaporation pond; and
recovering and conveying the oil separated from the water back to the oil processing facility.

6. The method of claim 1, further comprising:
draining the storm water in the first skimmer into the sump pit until a fluid level within the first skimmer drops to a level that causes a valve to unblock an opening through the separator wall; and
draining a portion of the storm water in the second oil skimmer into to the first oil skimmer through the opening in the separator wall.

7. An oil recovery system, comprising:
a first oil skimmer that receives storm water comprising water ladened with oil from an oil processing facility;
a sump pit in fluid communication with the first oil skimmer through a first drain, wherein the sump pit receives a portion of the storm water from the first oil skimmer;
one or more pumps arranged in the sump pit and operable to pump the portion of the storm water from the sump pit to an oil recovery tank;
a second oil skimmer separated from the first oil skimmer by a separator wall, wherein the second skimmer receives a portion of the storm water from the first oil skimmer when the storm water overflows the separator wall; and
an evaporation pond in fluid communication with the second oil skimmer to receive a portion of the water accumulated in the second oil skimmer and that has separated from the oil.

8. The oil recovery system of claim 7, further comprising one or more T-shaped pipes arranged within the second oil skimmer to facilitate fluid communication between the second oil skimmer and the evaporation pond.

9. The oil recovery system of claim 7, further comprising a floating barrier arranged to prevent oil floating on a surface of the water in the second oil skimmer from approaching the one or more T-shaped pipes.

10. The oil recovery system of claim 7, wherein the one or more pumps are two pumps.

11. The oil recovery system of claim 7, further comprising a float clapet valve disposed in the first skimmer and configured to block an opening through the separator wall when the storm water within the first skimmer reaches a fluid level threshold, and unblock the opening when the storm water within the first skimmer descends below the fluid level threshold.

12. The oil recovery system of claim 7, further comprising:
a second drain fluidly coupling the second oil skimmer with the sump pit; and
a valve arranged within the second drain and operable to control flow of the storm water from the second oil skimmer into the sump pit through the drain.

13. The oil recovery system of claim 7, wherein the first skimmer, the second skimmer, and the evaporation pond are part of the same structure.

14. An oil recovery system, comprising:
an evaporation pond;
a structure defining a first skimmer and a second skimmer, the structure including a weir wall dividing the first skimmer from the second skimmer, and the weir wall defining an opening extending between the first and second skimmers;
a valve disposed in the first skimmer at the opening, the valve being closed to block fluid communication between the first and second skimmers through the opening when a fluid level within the first skimmer is at or above a threshold level, and being opened to allow fluid communication between the first and second skimmers through the opening when the fluid level is below the threshold level; and
a T-shaped pipe partially disposed within the second skimmer to fluidly couple the second skimmer to the evaporation pond, the T-shaped pipe including a first portion and a second portion that intersects the first portion, the first portion including an inlet and an open end and the second portion including an outlet.

15. The oil recovery system of claim 14, wherein the structure defines the evaporation pond and the second portion of the T-shaped pipe extends through a first wall of the structure dividing the second skimmer from the evaporation pond.

16. The oil recovery system of claim 15, wherein the evaporation pond is disposed between the first wall and a second wall of the structure.

17. The oil recovery system of claim 16, further comprising:
an overflow drain formed through the second wall at a first elevation to inhibit overflowing of the second wall, and wherein the outlet of the T-shaped pipe is positioned within the evaporation pond at second elevation that is less than the first elevation.

18. The oil recovery system of claim 14, further comprising a floating barrier disposed in the second skimmer to inhibit oil floating on top of water within the second skimmer from reaching the T-shaped pipe.

19. The oil recovery system of claim 14, further comprising:
a sump pit;
a first drain extending from the first skimmer to the sump pit;
a second drain extending from the second skimmer to the sump pit; and
a valve configured to selectively control fluid flow through the second drain.

20. The oil recovery system of claim 19, wherein the evaporation pond is a first evaporation pond, and the oil recovery system further comprises an oil recovery tank configured to receive fluid from the sump pit, wherein oil is separated from water within the oil recovery tank, the oil is sent to an onshore oil facility through a first outlet of the oil recovery tank, and the water is sent to a second evaporation pond through a second outlet of the oil recovery tank.
